(19) United States
(12) Patent Application Publication
(10) Pub. No.: US 2024/0037480 A1
(43) Pub. Date: Feb. 1, 2024

(54) SYSTEM AND METHOD FOR DETECTING SIGNIFICANT CHANGE POINTS IN TIMESERIES CHART

(71) Applicant: JPMorgan Chase Bank, N.A., New York, NY (US)

(72) Inventors: Hannah ROWLEY, London (GB); Sourav SEN, Woking (GB)

(73) Assignee: JPMorgan Chase Bank, N.A., New York, NY (US)

(21) Appl. No.: 17/876,895

(22) Filed: Jul. 29, 2022

(51) Int. Cl. G06Q 10/06

(52) U.S. Cl. CPC G06Q 10/067

(57) ABSTRACT

A method for identifying valid change points includes plotting original timeseries data; plotting a scaled cumulative sum of deviance from a mean applied on the timeseries data for generating a cumulative sum (CUSUM) chart; applying a piecewise linear fit (PWLF) on the CUSUM chart for generating a PWLF segment chart; identifying potential change points on the PWLF segment chart; determining an angle formed at each of the potential change points; comparing the determined angle for each of the potential change points against a reference angle limit; when the determined angle is less than the reference angle limit, discarding a corresponding potential change point, and when the determined angle is greater than the reference angle limit, calculating a significance value for the corresponding potential change point; and identifying a valid change point based on the significance value.

### TECHNICAL FIELD

This disclosure generally relates to a system and method for providing a resiliency platform with an ability to visualize, plan and facilitate testing/simulation and deployment of capabilities of an organization ecosystem for providing enterprise resiliency.

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

Timeseries charts provide informative summaries of data to various users and may be presented. However, one of the challenges in data science is the detection of significant shifts in behavior of timeseries data, which may be phrased variously. In a timeseries chart, a point in time in which a new behavior is observed, such as a linearly increasing line that changes into a sinusoidal line, may be referred to as a change point. However, in auto detection of such change points may result in large number of false positives, leading to inefficient processing of technical resources (e.g., CPU, memory and the like), and may display an unnecessarily complex chart or graph that is difficult to decipher.

### SUMMARY

According to an aspect of the present disclosure, a method for identifying valid change points is provided. The method includes performing, using a processor and a memory: plotting original timeseries data; plotting a scaled cumulative sum of deviance from a mean applied on the timeseries data for generating a cumulative sum (CUSUM) chart; applying a piecewise linear fit (PWLF) on the CUSUM chart for generating a PWLF segment chart; identifying potential change points on the PWLF segment chart; determining an angle formed at each of the potential change points; comparing the determined angle for each of the potential change points against a reference angle limit; when the determined angle is less than the reference angle limit, discarding a corresponding potential change point; when the determined angle is greater than the reference angle limit, calculating a significance value for the corresponding potential change point; when the calculated significance value for the corresponding potential change point is less than a reference significance threshold, discarding the corresponding potential change point; when the calculated significance value for the corresponding potential change point is greater than the reference significance threshold, determining the corresponding potential change point as a valid change point; and appending the valid change point on the PWLF chart.

According to another aspect of the present disclosure, the PWLF segment chart includes a plurality of linear segments.

According to another aspect of the present disclosure, the reference angle limit is a fixed value.

According to yet another aspect of the present disclosure, the reference angle limit is 110 degrees.

According to another aspect of the present disclosure, the reference significance threshold is 0.5.

According to a further aspect of the present disclosure, wherein the significance value is calculated by: Significance=angle*magnitude_coefficient+persistence*persistence_coefficient+CUSUM*CUSUM_coefficient+support*support_coefficient, in which the angle refers to an angle degree between joining PWLF segments in the PWLF chart, the persistence refers to a distance from adjacent change points, the CUSUM refers to a CUSUM value at a respective change point, and the support refers to a number of times in which, a plurality of PWLF charts having n number of segments identifies a same valid change point.

According to yet another aspect of the present disclosure, the method further includes determining a target number of PWLF segments to be included in the PWLF chart.

According to a further aspect of the present disclosure, any additional PWLF segment above the target number of PWLF segments produce an accuracy improvement below a reference threshold.

According to another aspect of the present disclosure, the target number of PWLF segments is smallest number that meets an approximation limit between the CUSUM chart and the PWLF chart.

According to a further aspect of the present disclosure, the approximation limit between the CUSUM chart and the PWLF chart is calculated using a root mean squared deviation.

According to a further aspect of the present disclosure, a number of PWLF segments is iteratively added until the target number is reached.

According to a further aspect of the present disclosure, the target number is determined when a required root mean squared deviation of the PWLF chart to the CUSUM chart has been hit.

According to a further aspect of the present disclosure, each of the potential change points is formed at an intersection between adjacent PWLF segments.

According to a further aspect of the present disclosure, the significance value is a value that is greater than or equal to 0, and less than or equal to 1.

According to another aspect of the present disclosure, the appending of the valid change point on the PWLF chart includes appending a vertical line through the valid change point.

According to another aspect of the present disclosure, a magnitude of the vertical line indicates the significance value of the valid change point.

According to another aspect of the present disclosure, the PWLF chart follows a shape of the CUSUM chart.

According to another aspect of the present disclosure, the PWLF chart having the target number of PWLF segments follows a shape of the CUSUM chart.

According to another aspect of the present disclosure, a system for identifying valid change points is disclosed. The system includes at least one processor; at least one memory; and at least one communication circuit. The at least one processor is configured to perform: plotting original timeseries data; plotting a scaled cumulative sum of deviance from a mean applied on the timeseries data for generating a cumulative sum (CUSUM) chart; applying a piecewise linear fit (PWLF) on the CUSUM chart for generating a PWLF segment chart; identifying potential change points on the PWLF segment chart; determining an angle formed at each of the potential change points; comparing the determined angle for each of the potential change points against a reference angle limit; when the determined angle is less than the reference angle limit, discarding a corresponding potential change point; when the determined angle is greater than the reference angle limit, calculating a significance value for the corresponding potential change point; when the calculated significance value for the corresponding potential change point is less than a reference significance threshold, discarding the corresponding potential change point; when the calculated significance value for the corresponding potential change point is greater than the reference significance threshold, determining the corresponding potential change point as a valid change point; and appending the valid change point on the PWLF chart.

According to another aspect of the present disclosure, a non-transitory computer readable storage medium that stores a computer program for identifying valid change points is disclosed. The computer program, when executed by a processor, causing a system to perform a process including plotting original timeseries data; plotting a scaled cumulative sum of deviance from a mean applied on the timeseries data for generating a cumulative sum (CUSUM) chart; applying a piecewise linear fit (PWLF) on the CUSUM chart for generating a PWLF segment chart; identifying potential change points on the PWLF segment chart; determining an angle formed at each of the potential change points; comparing the determined angle for each of the potential change points against a reference angle limit; when the determined angle is less than the reference angle limit, discarding a corresponding potential change point; when the determined angle is greater than the reference angle limit, calculating a significance value for the corresponding potential change point; when the calculated significance value for the corresponding potential change point is less than a reference significance threshold, discarding the corresponding potential change point; when the calculated significance value for the corresponding potential change point is greater than the reference significance threshold, determining the corresponding potential change point as a valid change point; and appending the valid change point on the PWLF chart.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a significant change point detection system in accordance with an exemplary embodiment.

FIG. 2 illustrates an exemplary diagram of a network environment with a significant change point detection system in accordance with an exemplary embodiment.

FIG. 3 illustrates a system diagram for implementing a significant change point detection system in accordance with an exemplary embodiment.

FIG. 4 illustrates a method for identifying significant change point(s) in a timeseries chart in accordance with an exemplary embodiment.

FIG. 5A illustrates an original timeseries graph in accordance with an exemplary embodiment.

FIG. 5B illustrates an original timeseries plot along with a cumulative sum (CUSUM) chart in accordance with an exemplary embodiment.

FIG. 5C illustrates an original timeseries plot, along with a CUSUM chart and a Piecewise Linear Fit (PWLF) chart in accordance with an exemplary embodiment.

FIG. 5D illustrates a presence of two vertical lines that intersect potential change points with vertical heights representing significance of respective change points in accordance with an exemplary embodiment.

FIG. 5E illustrates a PWLF chart having two PWLF segments in accordance with an exemplary embodiment.

FIG. 5F illustrates a PWLF chart having three PWLF segments in accordance with an exemplary embodiment.

FIG. 5G illustrates a PWLF chart having four PWLF segments in accordance with an exemplary embodiment.

FIG. 5H illustrates no increase in accuracy by increasing the number of PWLF segments beyond four segments in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

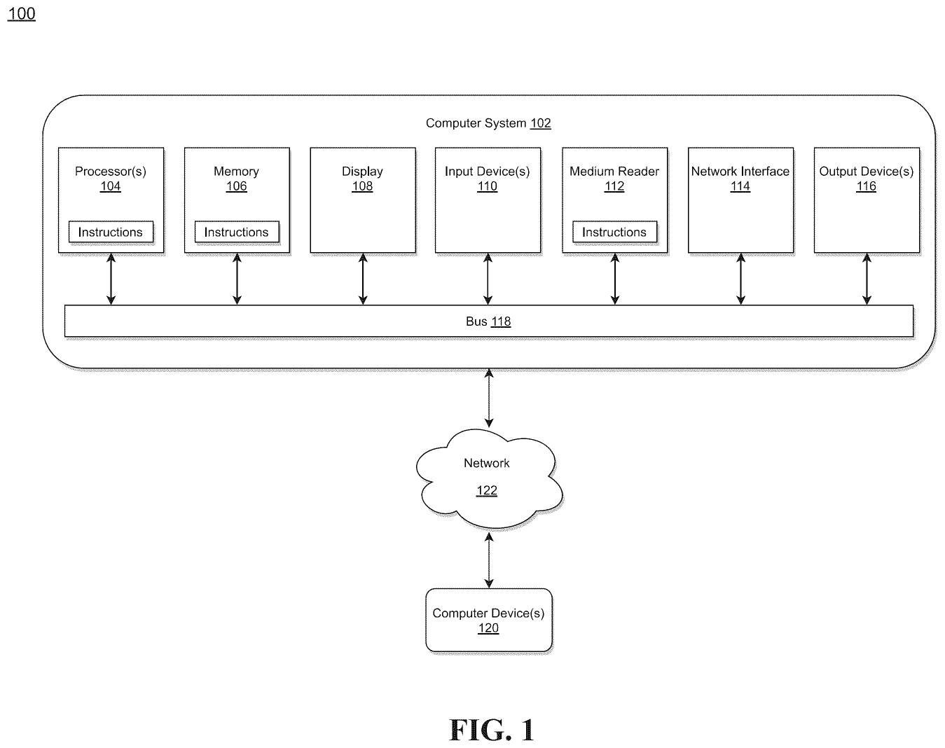

FIG. 1 illustrates a computer system for implementing a significant change point detection system in accordance with an exemplary embodiment.

The system 100 is generally shown and may include a computer system 102, which is generally indicated. The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The network interface 114 may include, without limitation, a communication circuit, a transmitter or a receiver. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

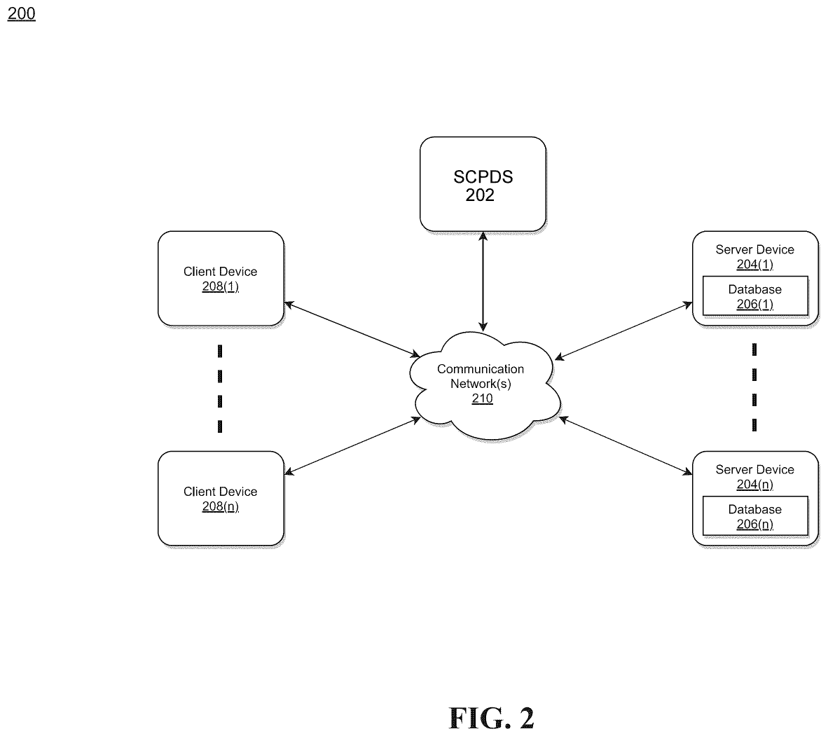

FIG. 2 illustrates an exemplary diagram of a network environment with a significant change point detection system in accordance with an exemplary embodiment.

A significant change point detection system (SCPDS) 202 may be implemented with one or more computer systems similar to the computer system 102 as described with respect to FIG. 1.

The SCPDS 202 may store one or more applications that can include executable instructions that, when executed by the SCPDS 202, cause the SCPDS 202 to perform actions, such as to execute, transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment or other networking environments. The application(s) may be executed within or as virtual machine(s) or virtual server(s) that may be managed in a cloud-based computing environment. Also, the application(s), and even the SCPDS 202 itself, may be located in virtual server(s) running in a cloud-based computing environment rather than being tied to one or more specific physical network computing devices. Also, the application(s) may be running in one or more virtual machines (VMs) executing on the SCPDS 202. Additionally, in one or more embodiments of this technology, virtual machine(s) running on the SCPDS 202 may be managed or supervised by a hypervisor.

In the network environment 200 of FIG. 2, the SCPDS 202 is coupled to a plurality of server devices 204(1)-204(n) that hosts a plurality of databases 206(1)-206(n), and also to a plurality of client devices 208(1)-208(n) via communication network(s) 210. According to exemplary aspects, databases 206(1)-206(n) may be configured to store data that relates to distributed ledgers, blockchains, user account identifiers, biller account identifiers, and payment provider identifiers. A communication interface of the SCPDS 202, such as the network interface 114 of the computer system 102 of FIG. 1, operatively couples and communicates between the SCPDS 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the SCPDS 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The SCPDS 202 may be a standalone device or integrated with one or more other devices or apparatuses, such as one or more of the server devices 204(1)-204(n), for example. In one particular example, the SCPDS 202 may be hosted by one of the server devices 204(1)-204(n), and other arrangements are also possible. Moreover, one or more of the devices of the SCPDS 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the SCPDS 202 via the communication network(s) 210 according to the HTTP-based protocol, for example, although other protocols may also be used. According to a further aspect of the present disclosure, in which the user interface may be a Hypertext Transfer Protocol (HTTP) web interface, but the disclosure is not limited thereto.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the SCPDS 202 that may efficiently provide a platform for implementing a cloud native SCPDS module, but the disclosure is not limited thereto.

The client devices 208(1)-208(n) may run interface applications, such as standard web browsers or standalone client applications, which may provide an interface to communicate with the SCPDS 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the SCPDS 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the SCPDS 202, the server devices 204(1)-204(n), or the client devices 208(1)-208(n), for example, may be configured to operate as virtual instances on the same physical machine. For example, one or more of the SCPDS 202, the server devices 204(1)-204(n), or the client devices 208(1)-208(n) may operate on the same physical device rather than as separate devices communicating through communication network(s) 210. Additionally, there may be more or fewer SCPDSs 202, server devices 204(1)-204(n), or client devices 208(1)-208(n) than illustrated in FIG. 2. According to exemplary embodiments, the SCPDS 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

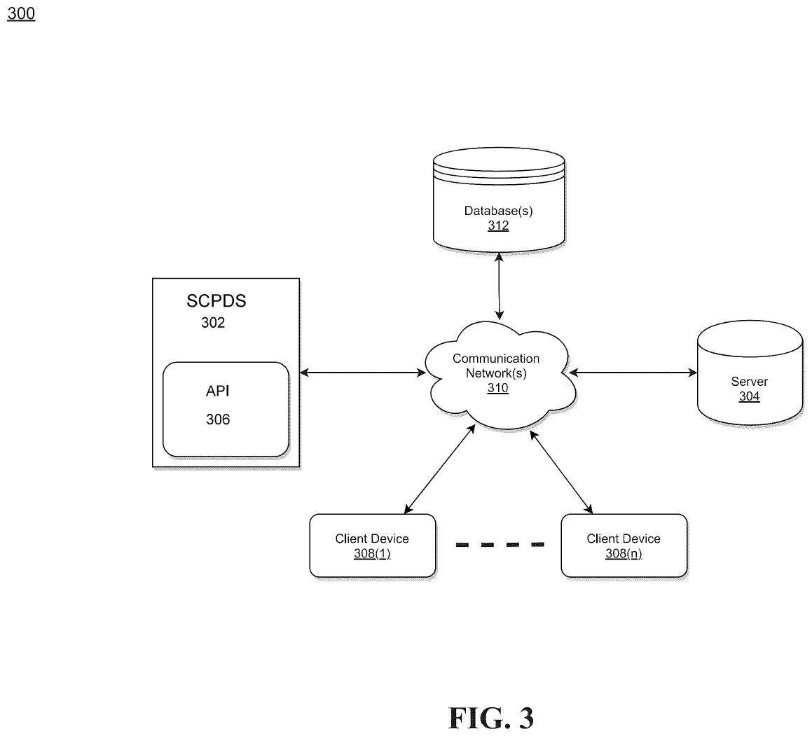

FIG. 3 illustrates a system diagram for implementing a significant change point detection system in accordance with an exemplary embodiment.

As illustrated in FIG. 3, the system 300 may include a site reliability engineering leaderboard system 302 within which a group of API modules 306 is embedded, a server 304, a database(s) 312, a plurality of client devices 308(1) . . . 308(n), and a communication network 310.

According to exemplary embodiments, the SCPDS 302 including the API modules 306 may be connected to the server 304, and the database(s) 312 via the communication network 310. Although there is only one database has been illustrated, the disclosure is not limited thereto. Any number of databases may be utilized. The SCPDS 302 may also be connected to the plurality of client devices 308(1) . . . 308(n) via the communication network 310, but the disclosure is not limited thereto.

According to exemplary embodiment, the SCPDS 302 is described and shown in FIG. 3 as including the API modules 306, although it may include other rules, policies, modules, databases, or applications, for example. According to exemplary embodiments, the database(s) 312 may be embedded within the SCPDS 302. According to exemplary embodiments, the database(s) 312 may be configured to store configuration details data corresponding to a desired data to be fetched from one or more data sources, user information data etc., but the disclosure is not limited thereto.

According to exemplary embodiments, the API modules 306 may be configured to receive real-time feed of data or data at predetermined intervals from the plurality of client devices 308(1) . . . 308(n) via the communication network 310.

The API modules 306 may be configured to implement a user interface (UI) platform that is configured to enable SCPDS as a service for a desired data processing scheme. The UI platform may include an input interface layer and an output interface layer. The input interface layer may request preset input fields to be provided by a user in accordance with a selection of an automation template. The UI platform may receive user input, via the input interface layer, of configuration details data corresponding to a desired data to be fetched from one or more data sources. The user may specify, for example, data sources, parameters, destinations, rules, and the like. The UI platform may further fetch the desired data from said one or more data sources based on the configuration details data to be utilized for the desired data processing scheme, automatically implement a transformation algorithm on the desired data corresponding to the configuration details data and the desired data processing scheme to output a transformed data in a predefined format, and transmit, via the output interface layer, the transformed data to downstream applications or systems.

The plurality of client devices 308(1) . . . 308(n) are illustrated as being in communication with the SCPDS 302. In this regard, the plurality of client devices 308(1) . . . 308(n) may be “clients” of the SCPDS 302 and are described herein as such. Nevertheless, it is to be known and understood that the plurality of client devices 308(1) . . . 308(n) need not necessarily be “clients” of the SCPDS 302, or any entity described in association therewith herein. Any additional or alternative relationship may exist between either or both of the plurality of client devices 308(1) . . . 308(n) and the SCPDS 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the SCPDS 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The SCPDS 302 may be the same or similar to the SCPDS 202 as described with respect to FIG. 2, including any features or combination of features described with respect thereto.

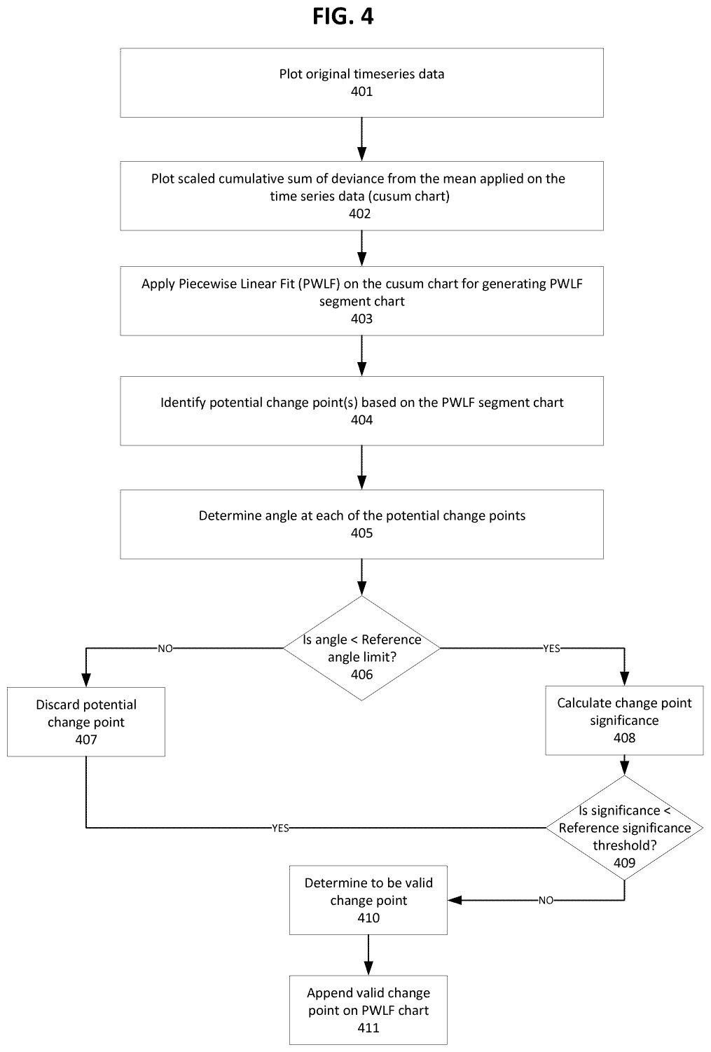

FIG. 4 illustrates a method for identifying significant change point(s) in a timeseries chart in accordance with an exemplary embodiment.

According to exemplary aspects of the present disclosure, in detecting change points in timeseries data, a cumulative sum of deviance from mean (CUSUM) of the timeseries data may be simplified to a piecewise linear chart of a few segments. Further, when the simplified piecewise linear chart is overlayed over the original timeseries data, a correlation between timeseries behavior shifts and intersection points between segments in the line graph or chart may be detected. Location of change points may match the location of intersection points in the piecewise linear chart and the extremity of the change points was higher where there was a smaller angle between adjacent piecewise linear chart segments.

According to exemplary aspects, a new gradient in a CUSUM chart may illustrate that the timeseries is moving in a new pattern compared to the mean line, and a steep change above a reference threshold may imply a big shift from the previous pattern from the mean. In an example, the reference threshold may be a fixed value or a value that is modified based on information calculated by a computer implemented algorithm or a machine learning algorithm.

According to exemplary aspects, the present disclosure reduces a number of line segments to provide an improved display of information to provide a more accurate context with the entire graph or chart.

A larger number of line segments calculated by conventional methodologies may pose danger of narrowing too much into a choppy or oscillating area of a graph or chart. A larger number of line segments may generate a number of incorrectly identified change points adjacent to one another. For example, in the conventional technologies, various peak and trough in the choppy region may be identified as a change point. However, not every peak and trough in the choppy region may not be an accurate change point. Instead, in such an example, a point between a choppy to a flat region may be more accurately identified as a change point.

In contrast to conventional technology that may identify various peaks and trough as a change point, exemplary aspects of the present disclosure provide using angles between segments of a piecewise linear fit approximation of the cumulative sum of the deviation from the mean of the original timeseries graph or chart to find change points and assigning a significance score. More specifically, the exemplary aspects of the present disclosure may use angles for detecting change point(s), and to discard insignificant changes with too large of an angle. The remaining change point(s) are assigned a base significance score using the angle magnitude. In an example, sharper the angle corresponding to a change point, a higher base significance score may be assigned. A more detailed description of the disclosed methodology is provided below with reference to the FIG. 4.

Reduction of detection of false change point(s) may lead to more efficient processing of the change point(s), which provide for faster processing speed by the CPU and efficient usage of memory in a computing device. Further, by eliminating or discarding of false change point(s), display of information may be improved to limit display to more pertinent data.

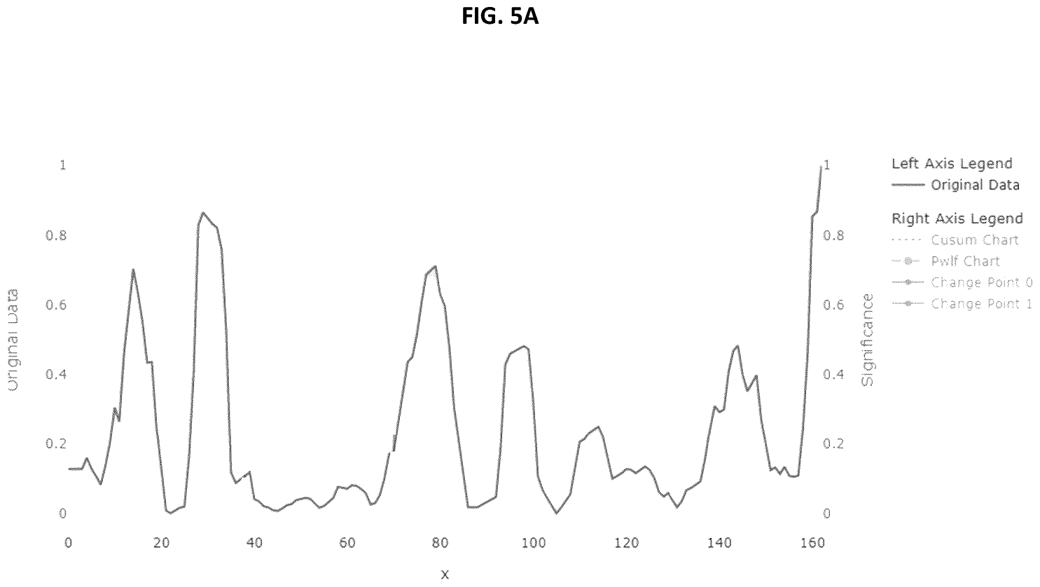

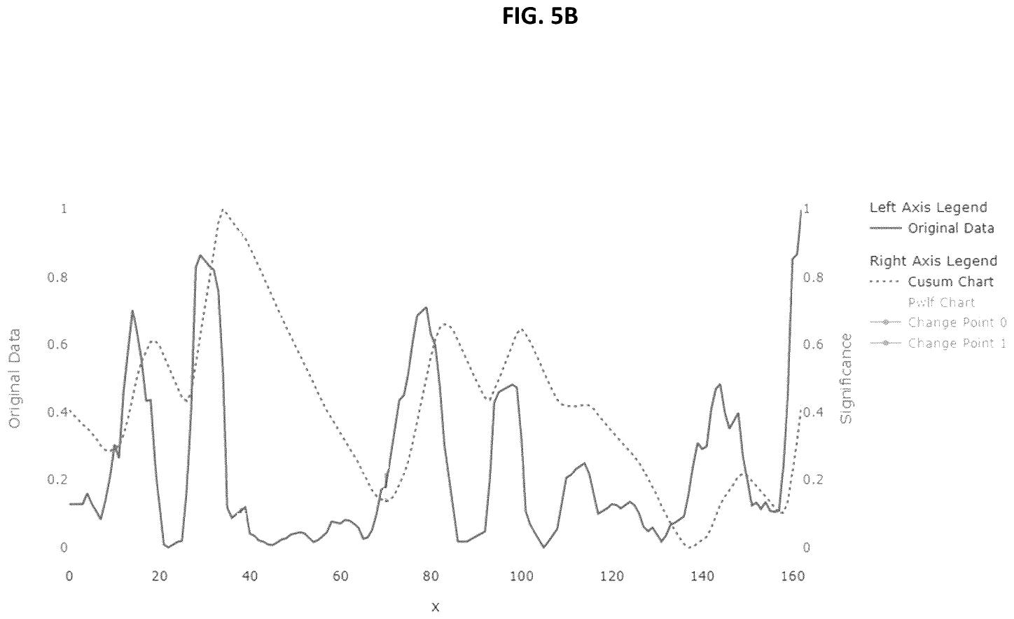

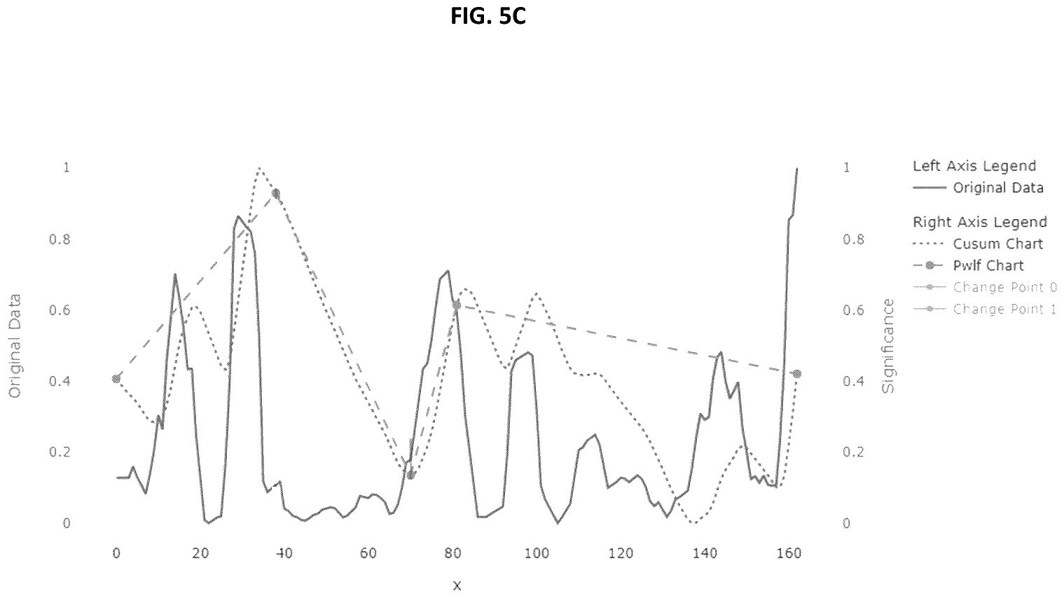

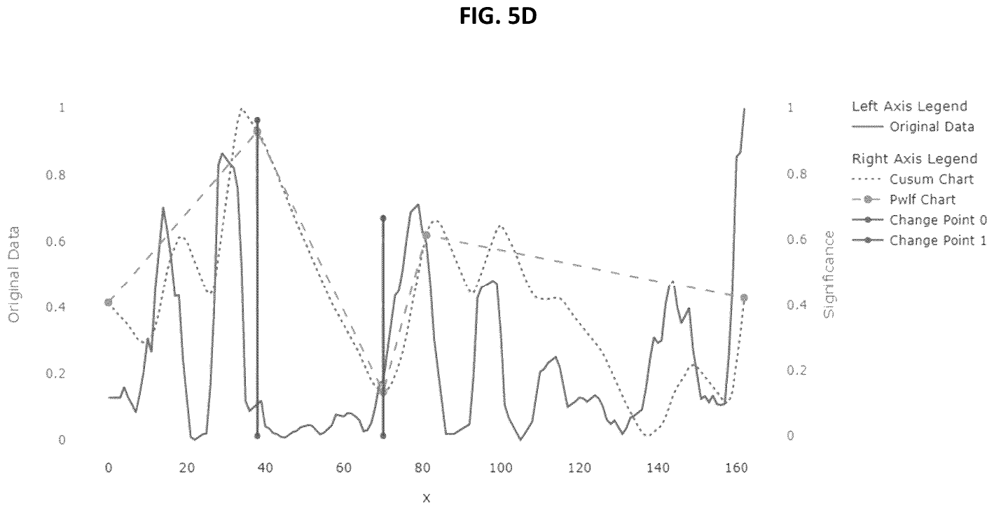

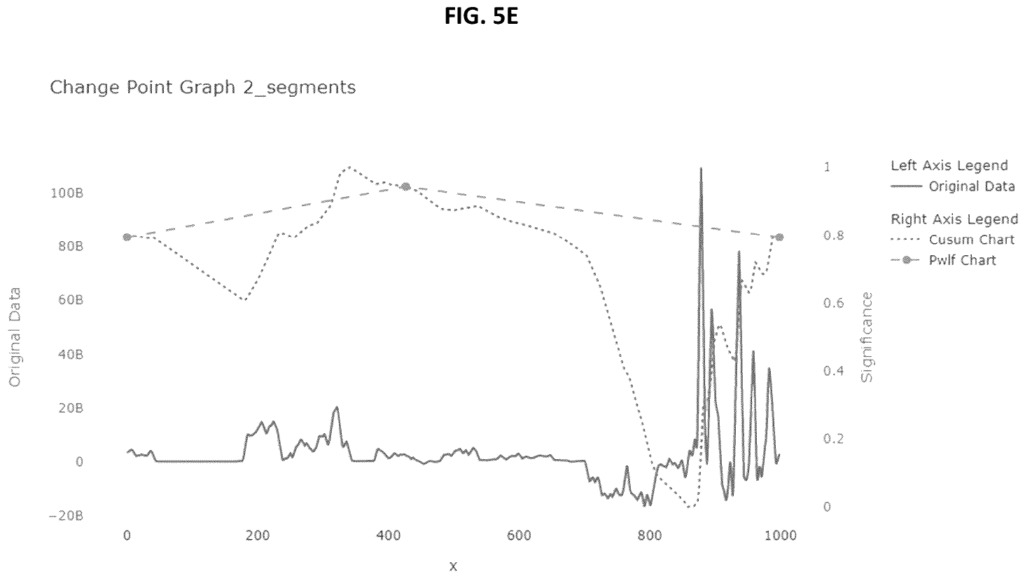

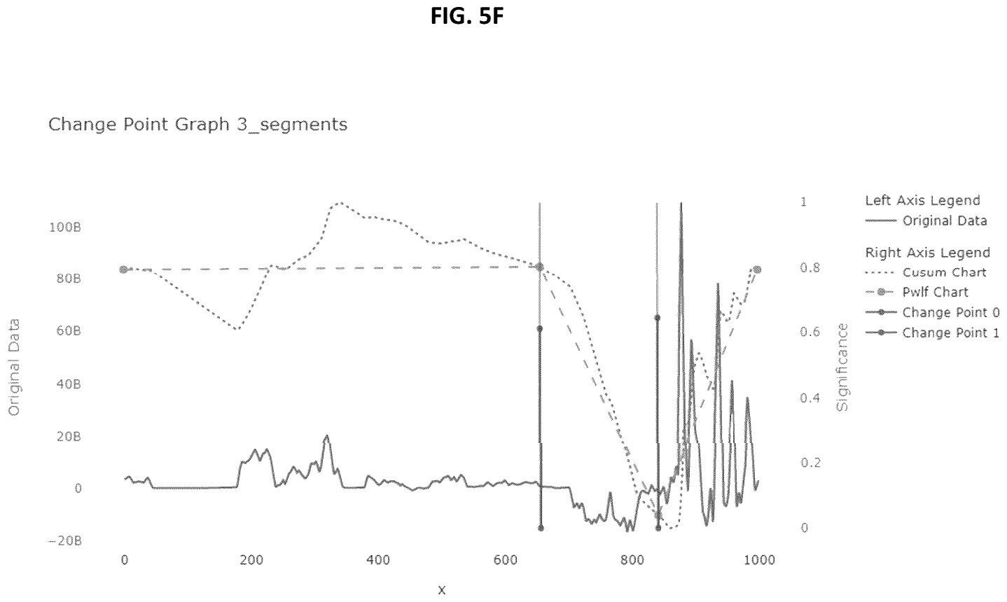

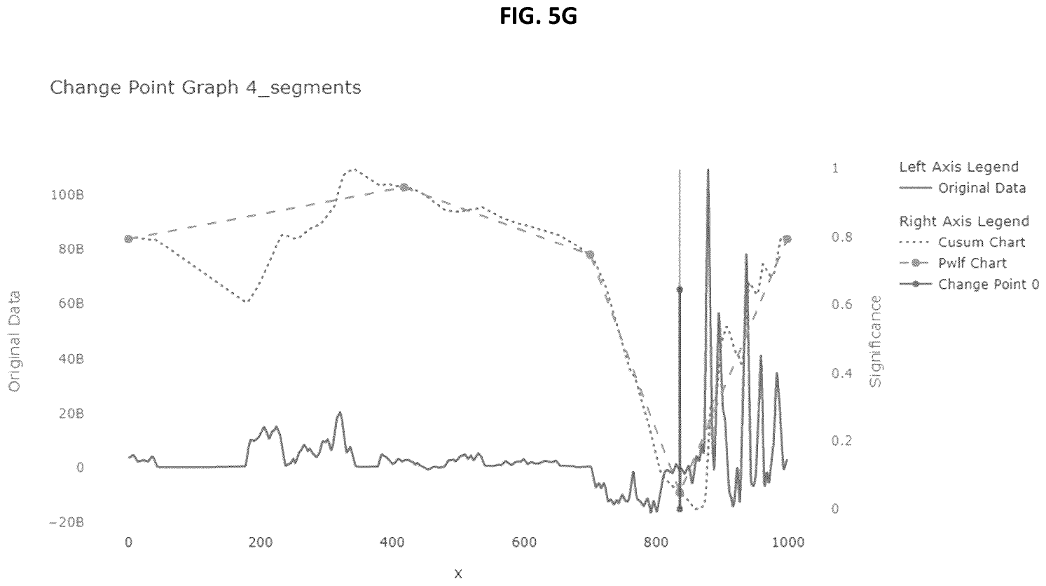

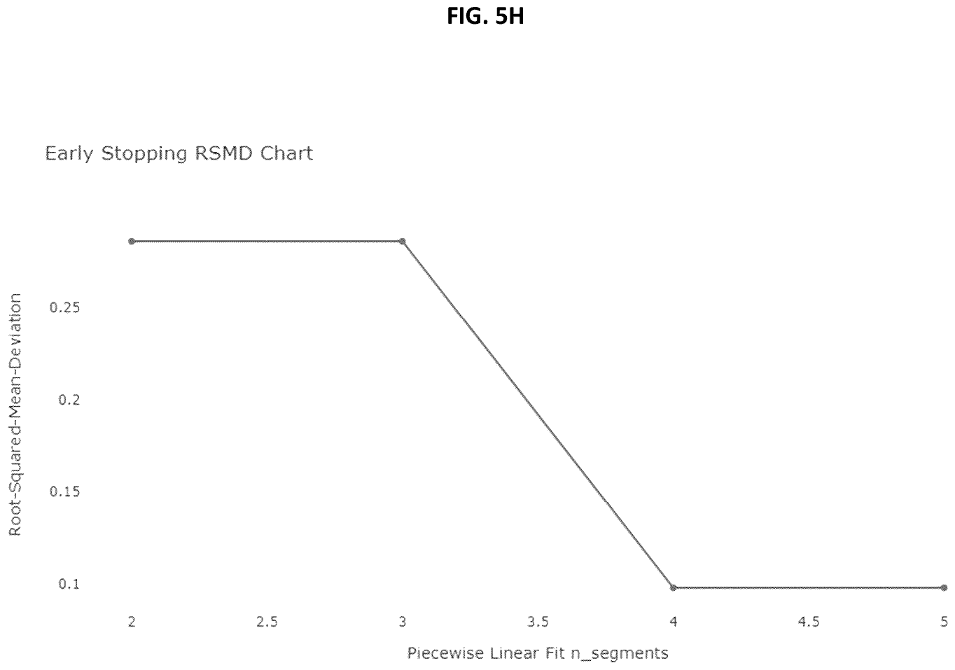

In operation 401, original data are plotted in a timeseries manner. In an example, FIG. 5A illustrates the original timeseries plot, graph or chart. A timeseries may refer to a series of data points indexed in time order. In an example, a timeseries may refer to a sequence taken at successive equally spaced points in time. In FIG. 5A, the plot of the original data is shown as a solid line.

In operation 402, a cumulative sum of deviance from a mean applied on the timeseries data may be plotted, and then scaled to original timeseries Y-axis. Such a chart may be referred to as a cumulative sum (CUSUM) chart. More specifically, the CUSUM chart is scaled prior to proceeding to operation 403, at least since an unscaled CUSUM chart would have a larger magnitude than the original timeseries data, which may result in piecewise linear fit (PWLF) angles to be overly small (e.g., less than 20 degrees) and inconsistent across different graphs. For example, angles may appear very different for a timeseries graph with a min-max of 1-0 versus a timeseries graph with a min-max of 100000-0. Scaling of the CUSUM chart may provide consistent or standardized angles to be provided across various timeseries graphs. According to exemplary aspects, CUSUM chart scaling may be calculated by a following formula:

(original, unscaled CUSUM chart)/(max of timeseries data−min of timeseries data)

In an example, FIG. 5B exemplarily illustrates the original timeseries plot along with the CUSUM chart that has been scaled. More specifically, FIG. 5B illustrates the CUSUM chart as a dashed line together with the plot of the original data.

In operation 403, PWLF is then applied to the CUSUM chart for generating a PWLF chart. FIG. 5C exemplarily illustrates the original timeseries plot, along with the CUSUM chart and the PWLF chart. The PWLF chart is illustrated as linear dashed line segments. In FIG. 5C, four PWLF segments are illustrated.

More specifically, PWLF is plotted by approximate PWLF of an unknown number of segments to the CUSUM chart. The unknown number may be represented by a variable n, where n may be a whole number (e.g., 0, 1, 2, 3, 4 and the like). In an example, the n value may be iteratively inputted until a target value is identified, or may be calculated by a machine learning algorithm. For example, FIG. 5E illustrates a PWLF chart having two PWLF segments, FIG. 5F illustrates a PWLF chart having three PWLF segments, and FIG. 5G illustrates a PWLF chart having four PWLF segments.

More specifically, FIG. 5E exemplarily illustrates that the PWLF chart with two PWLF segments is a poor approximation to the CUSUM chart. The one intersection formed by the two PWLF segments is not a valid change point as the angle between the PWLF segments is too large of a value. In FIG. 5F, the PWLF chart having three PWLF segments exemplarily illustrates that the first change point has a lower significance than the second change point as the angle magnitude is greater. In an example, a sharper angle may indicate a more extreme behavior shift in the timeseries. Lastly, FIG. 5G exemplarily illustrates the final result where the required root mean squared deviation of the approximated PWLF chart to the CUSUM chart has been hit. Further, as illustrated in FIG. 5G, the PWLF chart formed of four segments more accurately follows a shape of the CUSUM chart. In other words, the four PWLF segments in FIG. 5G provide an accurate approximation to the CUSUM chart.

According to exemplary aspects, the smallest n value that meets an approximation limit between the CUSUM chart and PWLF chart may be used to avoid unnecessary or wasteful computations. Such avoidance of unnecessary or wasteful computations may be referred to as early stopping. In an example, the approximation limit may be calculated by using a root mean squared deviation. Further, a computation may be determined to be unnecessary or wasteful when an increase in accuracy by additional adding of additional segment is below a reference threshold (or negligible) or nonexistent. For example, FIG. 5H illustrates no increase in accuracy by increasing the number of PWLF segments beyond four segments. For each iteration of increasing n value, the potential change point locations may be identified and recorded to be used later as support for individual change point significance calculations.

In operation 404, potential change point(s) are identified on the PWLF segment chart. In an example, each point where two PWLF segment intersects may be considered as a potential change point. FIG. 5D exemplarily illustrates presence of two vertical lines that intersect the potential change points with vertical height representing a significance of the respective change points.

In operation 405, an angle at each of the potential change point(s) is determined.

In operation 406, each of the determined angles is compared against a reference angle limit (e.g., 110 degrees). In an example, a large angle may indicate a small shift in behavior and not an extreme shift that may be significant. If the angle at the potential change point is larger (or not less than) than the reference angle limit, then the potential point is then disregarded in operation 407. For example, in FIG. 5G, it is observed that only one valid change point is available as the other two potential change points are disregarded for having too high of an angle, indicating only subtle behavior shift. According to exemplary aspects, the reference angle limit may be a fixed value or an adjustable value that may change as additional data are processed. In an example, the reference angle limit may be periodically or in real-time updated based on a computer implemented algorithm or a machine learning algorithm to provide more accurate results.

In an example, AI or ML algorithms may be executed to perform data pattern detection, and to provide an output or render a decision (e.g., identification of a fact to be extracted) based on the data pattern detection. More specifically, an output may be provided based on a historical pattern of data, such that with more data or more recent data, more accurate outputs and/or decisions may be provided or rendered. Accordingly, the ML or AI models may be constantly updated after a predetermined number of runs or iterations. According to exemplary aspects, machine learning may refer to computer algorithms that may improve automatically through use of data. Machine learning algorithm may build an initial model based on sample or training data, which may be iteratively improved upon as additional data are acquired.

More specifically, machine learning/artificial intelligence and pattern recognition may include supervised learning algorithms such as, for example, k-medoids analysis, regression analysis, decision tree analysis, random forest analysis, k-nearest neighbors analysis, logistic regression analysis, k-fold cross-validation analysis, balanced class weight analysis, and the like. In another exemplary embodiment, machine learning analytical techniques may include unsupervised learning algorithms such as, for example, Apriori analysis, K-means clustering analysis, etc. In another exemplary embodiment, machine learning analytical techniques may include reinforcement learning algorithms such as, for example, Markov Decision Process analysis, and the like.

In another exemplary embodiment, the ML or AI model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the ML or AI model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the ML or AI models may be generated using at least one from among an artificial neural network technique, a decision tree technique, a support vector machines technique, a Bayesian network technique, and a genetic algorithms technique.

On the other hand, the if the potential change point is less than the reference angle limit in operation 406, a significance value for the respective potential change point is then calculated in operation 408. In an example, the significance value for a potential change point is calculated using the below provided formula:

Significance=angle*magnitude_coefficient+persistence*persistence_coefficient+CUSUM*CUSUM_coefficient+support*support_coefficient

In the above noted formula, the angle may refer to an angle degree between joining PWLF segments, the persistence may refer to a distance from adjacent change points, the CUSUM may refer to a CUSUM value at the respective change point, and the support may refer to a number of times in which, numerous PWLF charts having n number of segments identifies the same valid change point. According to exemplary aspects, the coefficients in the provided formula may be a numerical value that is fixed or that is adjustable based on machine learning processing.

In operation 409, the calculated significance value(s) is compared against a reference significance threshold to determine whether the remaining potential change point(s) are significant or not. Only the change points with significance value above the reference significance threshold may be determined to be a valid change point. In an example, the significance value may be a value that is greater than or equal to 0, and less than or equal to 1, such as 0.5. In an example, the reference significance threshold may be a fixed value or a value that is adjusted by a computer implemented algorithm or a machine learning algorithm.

Accordingly, if the calculated significance value for a remaining potential change point (i.e., potential change points that have not been discarded based on angle) is determined to be less than the reference significance threshold in operation 409, then the method proceeds to operation 407 in which the respective change point is discarded. On the other hand, if the calculated significance value for a remaining potential change point is greater than (or not less than) the reference significance threshold in operation 409, then the respective change point is determined to be a valid change point in operation 410.

In operation 411 discloses appending the valid change point on the PWLF chart. The valid change point may also have a vertical line that runs through the valid change point to more prominently display to the user of the change point. Further, the vertical line may be of different magnitude or height to correspond to the significance value of the respective change point. Moreover, the change point and the corresponding vertical line may be displayed in a prominent color, such as red, to bring attention to the change point. Accordingly, a user may be able to quickly and easily identify the valid change points in a timeseries graph or chart. Additionally, at least since non-significant or invalid change points are discarded, processing may be performed only for the valid change points for a more efficient computer processing thereof.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for identifying valid change points, the method comprising:
performing, using a processor and a memory:
plotting original timeseries data;
plotting a scaled cumulative sum of deviance from a mean applied on the timeseries data for generating a cumulative sum (CUSUM) chart;
applying a piecewise linear fit (PWLF) on the CUSUM chart for generating a PWLF segment chart;
identifying potential change points on the PWLF segment chart;
determining an angle formed at each of the potential change points;
comparing the determined angle for each of the potential change points against a reference angle limit;
when the determined angle is less than the reference angle limit, discarding a corresponding potential change point;
when the determined angle is greater than the reference angle limit, calculating a significance value for the corresponding potential change point;
when the calculated significance value for the corresponding potential change point is less than a reference significance threshold, discarding the corresponding potential change point;
when the calculated significance value for the corresponding potential change point is greater than the reference significance threshold, determining the corresponding potential change point as a valid change point; and
appending the valid change point on the PWLF chart.

2. The method according to claim 1, wherein the PWLF segment chart includes a plurality of linear segments.

3. The method according to claim 1,
wherein the reference angle limit is a fixed value.

4. The method according to claim 3,
wherein the reference angle limit is 110 degrees.

5. The method according to claim 1,
wherein the reference significance threshold is 0.5.

6. The method according to claim 1,
wherein the significance value is calculated by:
Significance=angle*magnitude_coefficient+persistence*persistence_coefficient+CUSUM*CUSUM_coefficient+support*support_coefficient
wherein the angle refers to an angle between joining PWLF segments in the PWLF chart,
wherein the persistence refers to a distance from adjacent change points,
wherein the CUSUM refers to a CUSUM value at a respective change point, and
wherein the support refers to a number of times in which, a plurality of PWLF charts having n number of segments identifies a same valid change point.

7. The method according to claim 1, further comprising:
determining a target number of PWLF segments to be included in the PWLF chart.

8. The method according to claim 7,
wherein any additional PWLF segment above the target number of PWLF segments produce an accuracy improvement below a reference threshold.

9. The method according to claim 7,
wherein the target number of PWLF segments is smallest number that meets an approximation limit between the CUSUM chart and the PWLF chart.

10. The method according to claim 9,
wherein the approximation limit between the CUSUM chart and the PWLF chart is calculated using a root mean squared deviation.

11. The method according to claim 7,
wherein a number of PWLF segments is iteratively added until the target number is reached.

12. The method according to claim 11,
wherein the target number is determined when a required root mean squared deviation of the PWLF chart to the CUSUM chart has been hit.

13. The method according to claim 1,
wherein each of the potential change points is formed at an intersection between adjacent PWLF segments included in the PWLF chart.

14. The method according to claim 1,
wherein the significance value is a value that is greater than or equal to 0, and less than or equal to 1.

15. The method according to claim 1,
wherein the appending of the valid change point on the PWLF chart includes appending a vertical line through the valid change point.

16. The method according to claim 15,
wherein a magnitude of the vertical line indicates the significance value of the valid change point.

17. The method according to claim 1,
wherein the PWLF chart follows a shape of the CUSUM chart.

18. The method according to claim 7,
wherein the PWLF chart having the target number of PWLF segments follows a shape of the CUSUM chart.

19. A system to identify valid change points, the system comprising:
at least one processor;
at least one memory; and
at least one communication circuit,
wherein the at least one processor performs:
plotting original timeseries data;
plotting a scaled cumulative sum of deviance from a mean applied on the timeseries data for generating a CUSUM chart;
applying a PWLF on the CUSUM chart for generating a PWLF segment chart;
identifying potential change points on the PWLF segment chart;
determining an angle formed at each of the potential change points;
comparing the determined angle for each of the potential change points against a reference angle limit;
when the determined angle is less than the reference angle limit, discarding a corresponding potential change point;
when the determined angle is greater than the reference angle limit, calculating a significance value for the corresponding potential change point;
when the calculated significance value for the corresponding potential change point is less than a reference significance threshold, discarding the corresponding potential change point;
when the calculated significance value for the corresponding potential change point is greater than the reference significance threshold, determining the corresponding potential change point as a valid change point; and
appending the valid change point on the PWLF chart.

20. A non-transitory computer readable storage medium that stores a computer program for identifying valid change points, the computer program, when executed by a processor, causing a system to perform a process comprising:
plotting original timeseries data;
plotting a scaled cumulative sum of deviance from a mean applied on the timeseries data for generating a CUSUM chart;
applying a PWLF on the CUSUM chart for generating a PWLF segment chart;
identifying potential change points on the PWLF segment chart;
determining an angle formed at each of the potential change points;
comparing the determined angle for each of the potential change points against a reference angle limit;
when the determined angle is less than the reference angle limit, discarding a corresponding potential change point;
when the determined angle is greater than the reference angle limit, calculating a significance value for the corresponding potential change point;
when the calculated significance value for the corresponding potential change point is less than a reference significance threshold, discarding the corresponding potential change point;
when the calculated significance value for the corresponding potential change point is greater than the reference significance threshold, determining the corresponding potential change point as a valid change point; and
appending the valid change point on the PWLF chart.
